(19) United States
(12) Patent Application Publication
(10) Pub. No.: US 2006/0215165 A1
(43) Pub. Date: Sep. 28, 2006

(54) High sensitivity optical detection by temperature independent differential polarization surface plasmon resonance

(76) Inventor: Paul Melman, Newton, MA (US)

Correspondence Address: Newton Photonics, 104 Manet Road, Chestnut Hill, MA, 02467, US

(21) Appl. No.: 11/301,448

(22) Filed: Dec. 13, 2005

Related U.S. Application Data
(60) Provisional application No. 60/636,419, filed on Dec. 15, 2004.

(51) Int. Cl. G01N 21/55

(52) U.S. Cl. 356/445

(57) ABSTRACT

Detecting an amount of change in light intensity caused by surface plasmon resonance includes coupling light having transverse magnetic and transverse electric polarization modes into a slab waveguide having a metallic film that supports the surface plasmon resonance, detecting the transverse magnetic and transverse electric polarized light as it emanates from the slab waveguide, and determining an instantaneous difference in intensities between the transverse magnetic and transverse electric polarization modes of the emanated light. A thickness of the metal film may be varied to shift a response curve of the surface plasmon resonance, and the materials of a slab waveguide substrate may be selected to have a thermo-optic coefficient that substantially matches that of a test sample under analysis.

This application claims the benefit of U.S. Provisional Application No. 60/636,419 filed 15 Dec. 2004, which is incorporated by reference herein in its entirety.

### BACKGROUND

This invention relates to optical detection of analytes, and more particularly to detection of various substances including biological, biochemical, and chemical materials using surface plasmon resonance.

### BRIEF DESCRIPTION OF RELATED DEVELOPMENTS

Surface Plasmon Resonance (SPR) is the transfer of energy from electromagnetic radiation to electron waves (surface plasmon wave, SPW) on metal film surfaces. This energy transfer is resonant and occurs when the propagation velocity of the electromagnetic wave coincides with that of the SPW. This coincidence can be achieved by changing the angle of incidence of the electromagnetic radiation, by changing the wavelength of the electromagnetic radiation, or by changing the evanescent field distribution through the use of waveguides. The resonant nature of this effect makes the energy transfer very sensitive to the exact value of the refractive index within a thin (e.g. 150 nm) layer of a liquid over the metal film.

For example, when the metallic surface is exposed to a test sample (e.g., an antigen in aqueous solution) that interacts with a ligand (e.g., an antibody) immobilized on the metal surface, the binding reaction between the test sample and the ligand results in a change of index of refraction within the thin liquid layer. For example, the refractive index of pure water is ˜1.33 and that of most proteins is ˜1.5. This change causes a proportionate shift in the position of the resonance incidence angle or wavelength, or transmitted intensity through a waveguide, that can be monitored over time as the surface immobilized ligand binds more and more target molecules. A ligand layer is usually a collection of binding moieties attached to the metallic film either directly or using an intermediary.

Most techniques for SPR detection use a prism to generate total internal reflection at a surface. This surface may be coated with the thin metallic film which supports an SPW as mentioned above. See, e.g., U.S. Pat. Nos. 5,991,488 and 4,889,427. Changes in the incident light angle, or its wavelength, produce changes in propagation velocity along the prism surface and thus strongly affect the amplitude of the reflected light. The change of the index of refraction at the surface changes the angle at which the resonance occurs.

Most devices measure the change in the plasmon resonance angle. See, e.g., U.S. Pat. No. 4,889,427. Current devices are generally based on the Kretschmann geometry, as depicted in FIG. 1. In this geometry, a light beam, also referred to as a probe beam, 105 passes through a prism 110 and impinges on a thin metal film 120 at a particular angle of incidence 115. An evanescent wave propagates through the metal film 120 and excites surface plasmons at the interface between the metal film 120 and a sample under test 125. The propagation velocity of the evanescent field along the interface is a function of the angle of incidence 115. At a particular value of the incident angle 115 the propagation velocity of the incident beam equals that of the surface plasmon wave (resonant angle). At that angle, light is absorbed by free electrons in the metal film 120 substantially reducing the intensity of the reflected light. A change in the refractive index of the sample under test 125 adjacent to the metal film 120 causes the resonant angle to change.

Other configurations include the use of waveguides such as optical fibers or planar, single mode structures, designed to detect a shift of the SPR response curve, corresponding to a change in the index of refraction of the metallic film-abutting layer. See, e.g., U.S. Pat. Nos. 5,815,278; 5,485,277; and 5,359,681. Single planar waveguides can be used to detect changes in transmitted light intensity, but they lack a free parameter (such as angle) to trace out the response curve. Thus, any spurious change in transmitted light cannot be distinguished from a real signal. Some planar devices include a reference waveguide having a deactivated ligand layer. See U.S. Pat. No. 5,485,277. This reference waveguide may effectively counteract mechanical instabilities and nonspecific binding effects but requires a deactivation step.

Current SPR sensors are sometimes disadvantageous because of their sensitivity to ambient temperature. Detection limits of approximately 10⁻⁷ Refractive Index Units (RIU) enable reliable detection of approximately 1 to 10 picogram/mL of target proteins in aqueous solution. However, since a sensor's thermal noise is on the order of 10⁻⁴ RIU per 1 degree C., the ambient temperature must be stabilized within 1/1000 degree C. in order to realize the sensor's core sensitivity. In laboratory based analytical instruments the thermal noise may be minimized by stabilizing the temperature in the detection environment and by use of a temperature compensation channel. However, this solution is not adequate for field deployable diagnostic instruments because of the cost, bulk and power requirements of such a temperature stabilization system.

### SUMMARY

The disclosed embodiments are directed to a slab waveguide system for detecting an amount of change in light intensity caused by surface plasmon resonance including a slab waveguide and a metallic film that support the surface plasmon resonance, a light source that couples transverse magnetic and transverse electric polarization into the slab waveguide exciting the surface plasmon resonance in the metal film, a detector for detecting the transverse magnetic and transverse electric polarization as it emanates from the slab waveguide, and a processor for determining an instantaneous difference in intensities between the detected transverse magnetic and transverse electric polarization modes of the emanated light.

The metal film may have a thickness that when varied causes a shift in a response curve of the surface plasmon resonance. A substrate of the slab waveguide may include materials having a thermo-optic coefficient that substantially matches to that of a test sample under analysis.

The disclosed embodiments also include a method of detecting an amount of change in light intensity caused by surface plasmon resonance including coupling light having transverse magnetic and transverse electric polarization modes into a slab waveguide having a metallic film that supports the surface plasmon resonance, detecting the transverse magnetically and transverse electrically polarized light as it emanates from the slab waveguide, and determining an instantaneous difference in intensities between the transverse magnetic and transverse electric polarization modes of the emitted light.

In another embodiment, a slab waveguide system for detecting an amount of change in light intensity caused by surface plasmon resonance includes a slab waveguide and a metallic film that support the surface plasmon resonance, wherein the metal film has a thickness that when varied causes a shift in a response curve of the surface plasmon resonance, a light source that couples light into the slab waveguide exciting the surface plasmon resonance in the metal film, a detector for detecting the light as it emanates from the slab waveguide, and a processor for determining an intensity of the emanated light.

In yet another embodiment, a slab waveguide system for detecting an amount of change in light intensity caused by surface plasmon resonance includes a slab waveguide and a metallic film that support the surface plasmon resonance, wherein a substrate of the slab waveguide includes materials having a thermo-optic coefficient that substantially matches to that of a test sample under analysis, a light source that couples light into the slab waveguide exciting the surface plasmon resonance in the metal film, a detector for detecting light as it emanates from the slab waveguide, and a processor for determining an intensity of the light.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of a prior art SPR device;

FIG. 2 depicts a block diagram of an SPR detector with a slab waveguide design;

FIG. 3 depicts a block diagram of a system suitable for practicing the embodiments disclosed herein;

FIG. 4 shows exemplary surface plasmon response curves that are shifted by varying the thin metal film thickness; and

FIG. 5 shows the effects of material selection for temperature compensation.

### DETAILED DESCRIPTION OF THE EXEMPLARY EMBODIMENTS

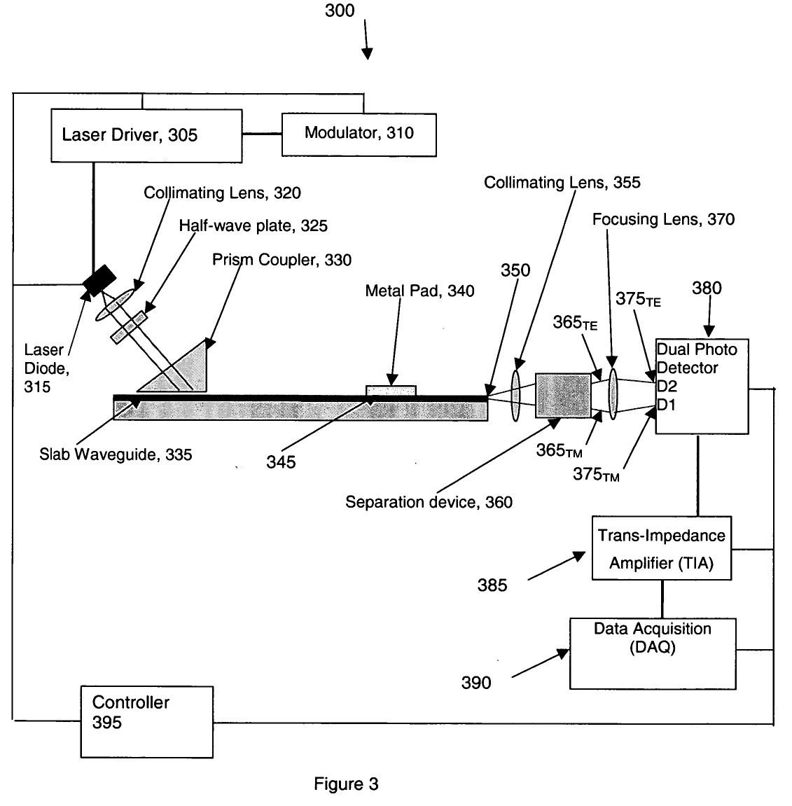

FIG. 3 shows a block diagram of a system 200 suitable for practicing the embodiments disclosed herein. Although the presently disclosed embodiments will be described with reference to the drawings, it should be understood that the embodiments may be realized in many alternate forms, utilizing any suitable size, shape or type of elements or materials.

The disclosed embodiments include an SPR detector based on a slab waveguide design, rather than a set of channel waveguides. The slab waveguide SPR detector design at the very least eliminates the highly precise angle measurement and stabilization required by Kretschmann configurations.

The disclosed embodiments also include a differential detection scheme based on measuring the instantaneous difference in intensities of transverse magnetic (TM) and transverse electric (TE) polarization modes of a probing light beam. The TM polarized light excites the SPW in the metal film and its transmitted intensity strongly depends on the refractive index at the metal film surface. The TE polarized light does not interact with the SPW and its intensity is insensitive to the refractive index at the metal film surface.

Another feature of the disclosed embodiments includes optimizing the metal film layer for specific analyses. It has been discovered that varying the metal layer thickness shifts the SPW response curve and thus allows use of a waveguide for testing samples having widely varying refractive indices.

Yet another feature of the disclosed embodiments includes a waveguide SPR configuration that is temperature independent, achieved by matching the thermo-optic coefficients of a waveguide substrate and a sample under test. For example, a polymer substrate with a thermo-optic coefficient equal in magnitude and sign to water may be used as part of a waveguide SPR chip for testing of aqueous samples.

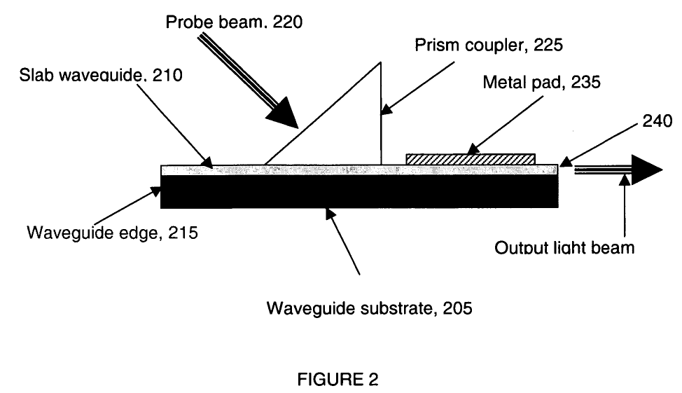

FIG. 2 depicts a block diagram of an SPR detector with a slab waveguide design. A slab waveguide is a waveguide that is constrained in only one dimension. For example, a slab waveguide may have a particular thickness while its length and width are such that they have little or no effect on the waveguide characteristics.

The slab waveguide based SPR detector may include a cladding layer 205. The cladding layer may be constructed of, for example, an optically transparent material such as silicon dioxide (e.g. glass, quartz, fused silica, etc.), borosilicate, or plastic. An optical slab waveguide 210 may be fabricated as a top layer, also referred to as the core, on the cladding layer 205, and may be constructed of a higher index of refraction material such as doped glass, chemically modified polymer or intensionally stressed layer of the cladding material. In another embodiment, the cladding layer may be formed as a substrate and a top layer of the substrate material may be modified to form the optical slab waveguide core 210. A probe beam 220 may be coupled to the waveguide 210 through a waveguide edge 215, a grating coupler (not shown), or through a prism coupler 225 as shown.

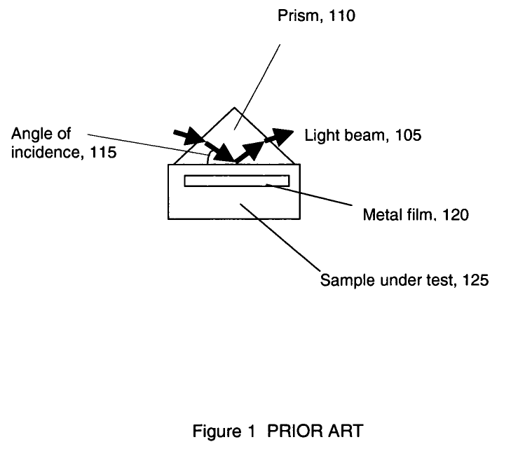

The prism coupler 225 is unrelated to the prism-coupled SPR in the Kretschmann configuration of FIG. 1 because the coupling angle of the prism coupler 225 is constant, selected to match the mode of the slab waveguide, and is independent of any SPR effects. Transmitted light emanates from a distal edge 240 of the SPR chip as an output light beam 230. One or more thin metal film pads 235 are deposited on the slab waveguide 210, over the light path. The thin metal film may be e.g. gold, silver, platinum, etc., or any other material that supports an SPW. Thus, in this embodiment, a light beam 220 is coupled into the slab waveguide 210, propagates through the waveguide 210 under the thin metal film 235 and exits the waveguide 210 at an output end 240.

The disclosed embodiments utilize a differential detection scheme where both transverse magnetic (TM) and transverse electric (TE) polarization modes of light are coupled into the slab waveguide. The instantaneous difference in intensity of the TM and TE modes is measured at the slab waveguide distal edge 240. The TM polarized light excites the SPW in the metal film 235 and its transmitted intensity strongly depends on the refractive index at the metal film surface. The TE polarized light does not interact with the SPW and its intensity is insensitive to the refractive index at the metal film surface. However, the optical coupling and light intensity fluctuations affect both TM and TE polarization modes. This makes the TE polarized light that is insensitive to SPR an ideal reference for differential SPR detection.

For efficient coupling of light into the slab waveguide, the angle of the incoming beam needs to be matched to the mode of the slab waveguide, as mentioned above. Since the propagation constants of the TE and TM modes are relatively close to each other, both polarization modes may be coupled simultaneously into the slab waveguide by using a slightly diverging input beam profile.

FIG. 3 shows a block diagram of a slab waveguide system 300 utilizing the differential TM-TE detection scheme. A laser driver 305 and modulator 310 drives a semiconductor laser diode 315. Light from the laser diode 315 is collimated by a lens 320. A half-wave plate 325 rotates the plane of polarization to equalize the TE and TM polarization modes. Thus, the laser diode 315 and the half wave late operate together to form a source of both TE and TM polarized light. A prism coupler 330 is used to couple the light into a slab waveguide 335. The slab waveguide 335 is constructed such that the indices of the TE and TM polarization modes are very close in value. As a result, a small beam divergence due to diffraction allows energy coupling to both polarization modes simultaneously.

The light propagates through the slab waveguide 335 underneath a thin film metal pad 340, typically made of gold. At an interface 345 between the slab waveguide 335 and the metal pad 340, the TM mode transfers part of its energy to a SPW, while the TE mode remains unaffected by the thin film metal pad 340. Thus, the TM mode operates as a probe indicating the amount of SPR shift while the TE mode operates as a reference. At a waveguide output facet 350 the beam is collimated by a lens 355. A separation device 360, for example a Wollaston prism, a polarization beam splitter, etc., separates the two polarization states into two beams 365_{TM}, 365_{TE} propagating at an angle with respect to each other, for example, 20°. A lens 370 may image the waveguide output facet 350 in two separate spots 375_{TM}, 375_{TE} on a photo detector 380, the first spot 375_{TM} for detecting TM polarized light and the second spot 365_{TE} for detecting TE polarized light. The spots may be separated approximately 1 cm. The lens 370 may have a focal length of approximately 3 cm. The photo detector 380 may include dual photodetectors D1 and D2 for detecting the probe (TM) and the reference (TE) beams, respectively.

The signals may be amplified using trans-impedance amplifiers 385, digitized using data acquisition circuitry 390, and sent to a controller 395 for processing which may include band-pass filtering and computing real time differences between the two light intensities. The controller may manage the operations of all the components of the slab waveguide system 300, in particular, the laser driver 305, modulator 310, laser diode 315, dual photo detector 380, trans-impedance amplifiers 385, and data acquisition circuitry 390.

The devices, methods, and systems of the differential waveguide SPR detection offer numerous advantageous in diverse contexts. They can be used to detect a change in a sample property, e.g., a temperature-induced change in viscosity, or a ligand-analyte interaction. They are suitable for laboratory use in both clinical and research settings. In a clinical setting, systems featuring differential SPR detection can enhance efficiency by analyzing a number of samples simultaneously for multiple analytes, with little effort required from the laboratory technician. In a research setting, the ability to study binding kinetics by collecting time-series data is particularly useful.

Differential waveguide SPR detection can also be used in the laboratory, since the devices are easy to use, portable, and inexpensive. The robustness of these systems avoids mechanical and optical instabilities, as well as the lack of human intervention required to maintain them, make them ideal for use in the field. In particular, configuring these SPR systems for communication of results to remote locations is especially attractive as it reduces communication time, transmission errors, and the need for the observer to be physically present at the location where the detection device is being used.

The disclosed embodiments include optimizing the metal film layer for specific analyses. The dynamic range of a waveguide based SPR response is generally somewhat limited. In prior art instrumentation, the SPR resonance curve may be shifted by changing the angle of incidence of the probe beam. In the waveguide based embodiments described herein, the incident angle is fixed, prohibiting this type of adjustment. However, as mentioned above, it has been discovered that varying the thickness of the metal film layer of the SPR detector operates to shift the surface plasmon resonance curve. Thus, the thickness of the metal film layer may be selected to optimize the response curve for a particular test sample.

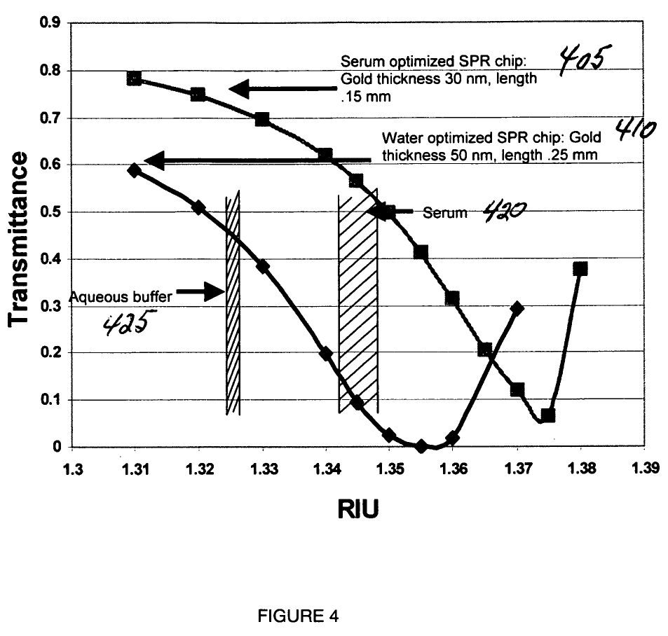

FIG. 4 shows two exemplary surface plasmon response curves (i.e., Transmittance vs. Refractive Index Unit). In the examples shown, the lower layer of the substrate, or cladding is glass with index 1.458, the upper layer of the substrate, or core, has a refractive index of 1.469, and the metal film layer is gold. The waveguide thickness is 2 micrometers. It has been found that increasing the thickness of the metal film layer of this type of detector configuration causes the surface plasmon response curve to shift toward lower refractive index unit values while decreasing the metal film thickness has the opposite effect. In this example, changing the gold film thickness from 30 nm to 50 nm shifts the response curve from a serum RIU range 420 usable for serum based testing 405 to an aqueous buffer RIU range 425 for water based testing 410. Thus, by varying the metal film layer, the surface plasmon response curve may be shifted. This allows a particular detection scheme to be used for different types of analysis, and conversely allows a surface plasmon response curve to be optimized for a specific detector or detector type. It should be noted that varying the thickness of the metal film may be utilized in other slab waveguide detection schemes and applications, independently from the differential detection system described herein.

SPR thermal drift is a major source of errors in SPR detectors, substantially limiting their sensitivity and stability. The dependence of the SPR signal on the sensor's surface temperature is a key source of noise that limits sensitivity. Aqueous solutions used in testing also generally exhibit significant thermo-optical effects. Active temperature stabilization may be practical in some cases when the temperature of the detector and test sample can be effectively controlled. However, for high sensitivity applications, active temperature stabilization may be impractical, in particular when the ambient temperature varies over a wide range.

It has been discovered that a detector may be designed which is temperature insensitive by selecting materials accordingly. In SPR designs generally, the resonance shifts with the change of the refractive index of the test sample, relative to the change in refractive index of the waveguide material. Water based solutions have a negative thermo-optic coefficient. For example, the refractive index of water changes by −1×10⁻⁴ per degree Celsius. This means that measurement of molecular interactions which produce an index change of, for example, 10⁻⁶ may require a temperature stabilization of better than 1/100 of a degree. In addition, glass has a positive thermo-optic coefficient of +1×10⁻⁵ per degree Celsius. Thus the refractive index difference between an aqueous sample and the detector's glass substrate varies significantly with temperature.

The disclosed embodiments include a method to achieve passive temperature compensation based on the following properties of surface plasmon waves. The resonant transfer of energy from the light beam to the plasmon wave occurs when the in-plane propagation velocity of the light equals that of the plasmon wave in the metal film. The propagation velocity of the surface plasmon wave depends on the index of refraction of the test sample (one side of the metal film) and the refractive index of the dielectric substrate underlying the metal film layer. On the other hand the propagation velocity of the light beam depends mostly on the refractive index of the substrate. In current SPR instruments, the substrate may be made of glass which, as mentioned above, has a thermo-optic coefficient of approximately +10⁻⁵/° C. Also as mentioned previously, water has negative thermo-optic coefficient of −10⁻⁴/° C. compounding a temperature dependent velocity mismatch that shifts the resonance point. Therefore, it would be advantageous to select a substrate material that has a thermo optical coefficient similar to that of the test sample.

It is important to note that polymers exhibit thermo-optic coefficients very similar to water in both magnitude and sign. For example, when using a standard acrylic polymer as a substrate with a thermo-optic coefficient −1.1×10⁻⁴/° C., substantially matching that of water, the temperature sensitivity of an SPR chip may be reduced approximately ten-fold. Polymers may also be modified to fine tune the thermo-optic coefficient and a matching of 10⁻⁶/° C. may be achieved. For example, a substrate material, such as an acrylic may be chemically modified to match the thermo optical characteristics of a particular sample. As another example, the chip temperature may be changed slightly and kept within 1 degree Centigrade. This type of fine tuning may achieve a thermo-optic coefficient matching of better than 10⁻⁻⁶/° C. For purposes of the disclosed embodiments, the substrate refers to the core and cladding of the waveguide, collectively.

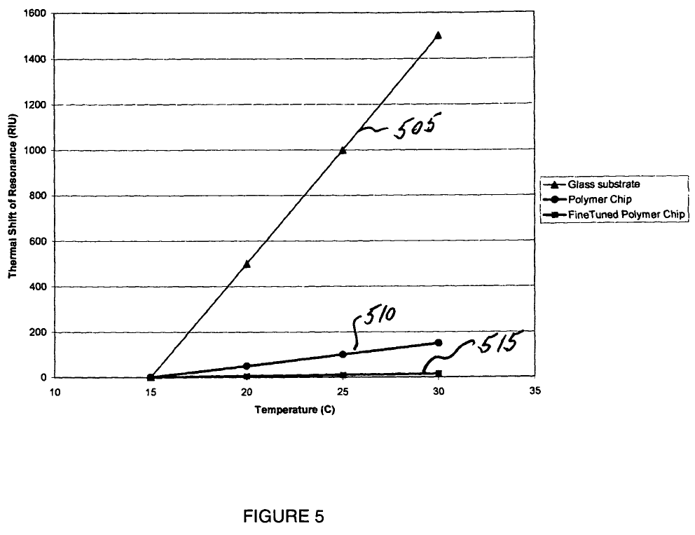

FIG. 5 shows three curves that demonstrate the effects of material selection and fine tuning as described herein. Curve 505 shows the temperature sensitivity of an exemplary SPR chip using a conventional glass substrate. Curve 510 shows the temperature sensitivity of an SPR chip constructed on a polymer substrate without any fine tuning of the thermo-optic coefficient. Curve 515 shows the temperature sensitivity of an SPR chip constructed on a polymer substrate that has been fine tuned to achieve a thermo-optic coefficient that matches a particular sample.

FIG. 5 demonstrates the dramatic improvement in thermal stability of SPR-based instrumentation when using thermo-optic coefficient matched chips. Even the simplest approach to thermo-optic coefficient matching shown in curve 510 may result in a dramatic improvement in detection limits. It should be understood that the techniques of matching the thermo-optic coefficient of the substrate material to that of the test sample may employed in other slab waveguide detection schemes and applications, independently from the differential detection system described herein.

The disclosed embodiments are advantageous in that the slab waveguide design at the very least eliminates the highly precise angle measurement and stabilization required by Kretschmann configurations. In addition, the differential detection scheme based on measuring the instantaneous difference in intensities of transverse magnetic (TM) and transverse electric (TE) polarization modes provides a more precise determination of the surface plasmon resonance point than prior art techniques. By optimizing the metal film layer for specific analyses the slab waveguide based detector may be used for testing samples having widely varying refractive indices. The temperature independent waveguide SPR configuration provides a significant improvement in thermal noise immunity resulting in superior detection limits.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A slab waveguide system for detecting an amount of change in light intensity caused by surface plasmon resonance comprising:
a slab waveguide and a metallic film that support the surface plasmon resonance;
a light source that couples transverse magnetic and transverse electric polarization into the slab waveguide exciting the surface plasmon resonance in the metal film;
a detector for detecting the transverse magnetic and transverse electric polarization as it emanates from the slab waveguide; and
a processor for determining an instantaneous difference in intensities between the detected transverse magnetic and transverse electric polarization modes of the emanated light.

2. The slab waveguide system of claim 1, wherein the metal film has a thickness that when varied causes a shift in a response curve of the surface plasmon resonance.

3. The slab waveguide system of claim 1, wherein a substrate of the slab waveguide includes materials having a thermo-optic coefficient that substantially matches to that of a test sample under analysis.

4. The slab waveguide system of claim 1, wherein the slab waveguide includes a cladding layer of at least one of silicon dioxide, borosilicate, or polymer.

5. The slab waveguide system of claim 4, wherein the slab waveguide includes a core of dielectric material with refractive index higher than that of the cladding.

6. The slab waveguide system of claim 1, wherein the light source comprises a laser diode and a half wave plate.

7. The slab waveguide system of claim 1, further comprising a separation device for separating the transverse magnetic and transverse electric polarized light emanating from the slab waveguide and for conveying the separated light to the detector.

8. The slab waveguide system of claim 7, wherein the detector includes dual photodetectors for detecting the separated transverse magnetic and transverse electric polarized light.

9. A method of detecting an amount of change in light intensity caused by surface plasmon resonance comprising:
coupling light having transverse magnetic and transverse electric polarization modes into a slab waveguide having a metallic film that supports the surface plasmon resonance;
detecting the transverse magnetic and transverse electric polarized light as it emanates from the slab waveguide; and
determining an instantaneous difference in intensities between the transverse magnetic and transverse electric polarization modes of the emitted light.

10. The method of claim 9, further comprising varying a thickness of the metal film to shift a response curve of the surface plasmon resonance.

11. The method of claim 9, further comprising selecting materials of a slab waveguide substrate having a thermo-optic coefficient that substantially matches that of a test sample under analysis.

12. The method of claim 9, further comprising separating the transverse magnetic and transverse electric polarized light emanating from the slab waveguide before detection.

13. The method of claim 9, further comprising detecting the transverse magnetic and transverse electric polarized light using dual photodetectors.

14. A slab waveguide system for detecting an amount of change in light intensity caused by surface plasmon resonance comprising:
a slab waveguide and a metallic film that support the surface plasmon resonance, wherein the metal film has a thickness that when varied causes a shift in a response curve of the surface plasmon resonance;
a light source that couples light into the slab waveguide exciting the surface plasmon resonance in the metal film;
a detector for detecting the light as it emanates from the slab waveguide; and
a processor for determining an intensity of the emanating light.

15. The slab waveguide system of claim 14, wherein the light coupled into the slab waveguide includes transverse magnetic and transverse electric polarization.

16. The slab waveguide system of claim 15, wherein the detector detects the transverse magnetic and transverse electric polarization in the light emanating from the slab waveguide.

17. The slab waveguide system of claim 16, wherein the processor operates to determine an instantaneous difference in intensities between the detected transverse magnetic and transverse electric polarization modes of the emanated light.

18. A slab waveguide system for detecting an amount of change in light intensity caused by surface plasmon resonance comprising:
a slab waveguide and a metallic film that support the surface plasmon resonance, wherein a substrate of the slab waveguide includes materials having a thermo-optic coefficient that substantially matches to that of a test sample under analysis;
a light source that couples light into the slab waveguide exciting the surface plasmon resonance in the metal film;
a detector for detecting light as it emanates from the slab waveguide; and
a processor for determining an intensity of the light.

19. The slab waveguide system of claim 18, wherein the light coupled into the slab waveguide includes transverse magnetic and transverse electric polarization.

20. The slab waveguide system of claim 19, wherein the detector detects the transverse magnetic and transverse electric polarization in the light emanating from the slab waveguide.

21. The slab waveguide system of claim 20, wherein the processor operates to determine an instantaneous difference in intensities between the detected transverse magnetic and transverse electric polarization modes of the emanated light.
